(19) United States
(12) Patent Application Publication
(10) Pub. No.: US 2026/0309589 A1
(43) Pub. Date: Oct. 8, 2026

(54) AUTOMATIC SAMPLING DEVICE

(71) Applicant: Interface Intelligence Company, Toufen City (TW)

(72) Inventors: Kuei-Pin CHANG, Toufen City (TW); Meng-Chi Chen, Toufen City (TW); Jen-Shuo Liu, Toufen City (TW)

(21) Appl. No.: 19/634,527

(22) Filed: Mar. 31, 2026

(30) Foreign Application Priority Data
Apr. 2, 2025 (TW) 114112900

(51) Int. Cl. G01N 1/10

(52) U.S. Cl. CPC G01N 1/10

(57) ABSTRACT

The present disclosure provides an automatic sampling device, which is suitable for transferring a container to automatically complete sampling. The automatic sampling device includes a housing, a carrying module, a power module, an operation module, and a controller. The carrying module includes a driving member and a carrying base. The driving member may be disposed in the housing and be linearly displaceable in a first direction. The carrying base is rotatable about the first direction. The power module is displaceable in the first direction. The operation module is disposed on a displacement path of the carrying module, and includes a cleaning unit, a sampling unit, and a bottle cap opening and closing unit. The cleaning unit, the sampling unit, and the bottle cap opening and closing unit are configured at intervals. The controller is electrically connected to a driving unit and the operation module.

### CROSS-REFERENCE TO RELATED APPLICATION

This non-provisional application claims priority under 35 U.S.C. § 119(a) to Patent

Application No. 114112900 filed in Taiwan, R.O.C. on Apr. 2, 2025, the entire contents of which are hereby incorporated by reference.

### BACKGROUND

### Technical Field

The present disclosure relates to a sampling device, and in particular, to an automatic sampling device.

### Related Art

In a manufacturing process of each field, different solutions usually need to be used. In the semiconductor field, different chemical solutions are commonly used in the manufacturing process. As precision of a semiconductor has advanced to a nanometer scale, every link in the manufacturing process has significant influence on a manufacturing process yield. To ensure the manufacturing process yield, quality requirements for the chemical solutions used in the manufacturing process also need to be strictly managed and controlled. To ensure quality (for example, cleanliness) of the chemical solutions used in the manufacturing process, chemicals used in the manufacturing process need to be periodically detected.

To sample the chemicals in the manufacturing process, a sample is usually loaded in a container and is then sent to an inspection party for detection. However, to ensure consistency between the obtained sample and a sample used in the manufacturing process, a cleaning procedure needs to be first performed before the container is loaded with the sample, and the container can continue be used to load the sample only after it is ensured that no other possible ingredients are remained in the container.

A general sampling method is to clean the container through a manual operation before a sampling operation is performed. Although steps for cleaning the container are strictly designed, even if the same sampling step is performed, each operation performed by the same operator may be slightly different. Therefore, when the same sampling step is performed by different operators, a difference inevitably exists as well. Therefore, in a common sampling process, it is difficult to standardize all the operation steps, and the consistency between the obtained sample and the sample used in the manufacturing process cannot be completely ensured either. In this way, accuracy of subsequent detection and accuracy of a determining result may also be affected, and accurate determining cannot be provided at a stage of solution control and management. Further, uncertainty may also be generated in the manufacturing process. Therefore, the common sampling process needs to be improved.

### SUMMARY

The present disclosure provides an automatic sampling device, which is suitable for transferring a container to automatically complete sampling. The automatic sampling device includes a housing, a carrying module, a power module, an operation module, and a controller. The carrying module includes a driving member and a carrying base. The driving member is disposed in the housing and is linearly displaceable in a first direction. The carrying base is connected to the driving member and is driven by the driving member to rotate about the first direction. The power module is connected to the driving member to drive the driving member to be displaced in the first direction. The operation module is disposed on a displacement path of the carrying module, and includes a cleaning unit, a sampling unit, and a bottle cap opening and closing unit, where the cleaning unit, the sampling unit, and the bottle cap opening and closing unit are configured at intervals. The controller is electrically connected to the driving unit, the power module, and the operation module.

In this way, the automatic sampling device can automatically complete a preliminary operation of a sampling operation and the sampling operation in the housing, and standardize a sampling process, so that pollution of the sampling operation can be avoided, and in addition to that, efficiency of the sampling operation can also be improved, and consistency of the sampling operation can be ensured. The carrying module carries the container to complete the automatic sampling operation in a linear displacement manner. In this way, a volume of an entire automatic sampling device can also be reduced, and field applicability is improved.

In some embodiments, a direction perpendicular to the first direction is a second direction, and the power module and the carrying module are respectively located at different positions in the second direction in the housing.

In some embodiments, the housing further includes a first partition, the first partition extends in the first direction and is parallel to the carrying module, the first partition has a long hole, the long hole has a length extending in the first direction, the carrying module and the power module are respectively located on opposite sides of the first partition, and the power module is connected to the driving member through the long hole.

In some embodiments, the carrying module further includes a box body, the driving member is accommodated inside the box body, the carrying base is located outside the box body, and the power module is connected to the box body.

In some embodiments, the carrying base includes a fixed base and a clamping member, the fixed base is connected to the driving member, and the clamping member is disposed on a side of the fixed base and is linearly displaceable in the first direction.

In some embodiments, the housing further includes a second partition, one end of the second partition is angularly connected to the first partition and the second partition has a pass-through port, the second partition and the carrying module are located on a same side of the first partition, and the operation module is located on a side of the second partition.

In some embodiments, the carrying module is sequentially displaced between a first position, a second position, a third position, and a fourth position in the first direction, and when the carrying module is located at the first position, the carrying base is located on the other side of the second partition through the pass-through port.

In some embodiments, the automatic sampling device further includes a door sheet and a driving assembly, a direction perpendicular to the first direction is a second direction, the driving assembly is disposed in the housing, the door sheet is connected to the driving assembly, and the driving assembly is capable of driving the door sheet to be displaced in a third direction perpendicular to the first direction and the second direction to open and close the pass-through port.

In some embodiments, the driving assembly includes a gear, a rack, and a power source, the gear is rotatably disposed in the housing, the rack has a length extending in the third direction and the rack is fixed to the door sheet and is meshed with the gear, and the power source is connected to the gear.

In some embodiments, the bottle cap opening and closing unit includes a lifting module, a rotating module, and a clamping module. The lifting module is fixed to the housing, the rotating module is connected to the lifting module, and the clamping module is connected to the rotating module.

In some embodiments, the lifting module has a sliding table. The sliding table is slidable in the third direction perpendicular to the first direction, and the rotating module is connected to the sliding table.

In some embodiments, the rotating module includes a motor and a driving shaft. The motor is fixed to the sliding table, the driving shaft is connected to the motor and is capable of rotating about the third direction, and the clamping module is connected to the driving shaft.

In some embodiments, the clamping module includes a kit and two clamping members. The kit has a sleeve, and the clamping members are disposed on two opposite sides in the sleeve and are linearly displaceable.

In some embodiments, the automatic sampling device further includes two sliding sheet groups, respectively disposed on a side of the first partition away from the carrying module, where each of the sliding sheet groups includes a plurality of sliding sheets and a plurality of limiting members, the sliding sheets are parallel to each other and at least partially overlap, each of the sliding sheets has a sliding groove provided in the first direction, and each of the limiting members is slidably disposed in sliding grooves of two adjacent sliding sheets, in each sliding sheet group, the sliding sheet closest to the first partition is fixed to the carrying module, and the sliding sheet farthest from the first partition is fixed to the housing.

In some embodiments, the housing further includes fourth partitions. The fourth partitions are spaced in parallel on the side of the first partition away from the carrying module, and the sliding sheet groups are located between the first partition and the fourth partition.

### BRIEF DESCRIPTION OF THE DRAWINGS

FIG. 1 is a schematic diagram of an overall appearance of an automatic sampling device according to an embodiment of the present disclosure;

FIG. 2 is a schematic cross-sectional view drawn along a section line 2-2 in FIG. 1;

FIG. 3 is a schematic cross-sectional view of a carrying module that is located at a first position and that is of an automatic sampling device according to an embodiment of the present disclosure and is drawn along a section line 3-3 in FIG. 1;

FIG. 4 is a partially enlarged view of a part 4 circled in FIG. 3;

FIG. 5 is a schematic cross-sectional view of a carrying base of an automatic sampling device according to an embodiment of the present disclosure;

FIG. 6 is a schematic cross-sectional view of a carrying module that is located at a second position and a third position and that is of an automatic sampling device according to an embodiment of the present disclosure;

FIG. 7 is a schematic cross-sectional view of a carrying module that is located at a fourth position and that is of an automatic sampling device according to an embodiment of the present disclosure;

FIG. 8 is a cross-sectional view 1 of an automatic sampling device from another perspective according to an embodiment of the present disclosure and is drawn along a section line 8-8 in FIG. 1;

FIG. 9 is a schematic cross-sectional view of an automatic sampling device from still another perspective according to an embodiment of the present disclosure;

FIG. 10 is a schematic block diagram of a cleaning unit of an automatic sampling device according to an embodiment of the present disclosure;

FIG. 11 is a cross-sectional view 2 of an automatic sampling device from another perspective according to an embodiment of the present disclosure;

FIG. 12 is a cross-sectional view 3 of an automatic sampling device from another perspective according to an embodiment of the present disclosure;

FIG. 13 is a partially enlarged view of a part 13 circled in FIG. 8;

FIG. 14 is a partially enlarged view of a part 14 circled in FIG. 11; and

FIG. 15 is a partially enlarged cross-sectional view of a part 15 circled in FIG. 9.

### DETAILED DESCRIPTION

Before the present disclosure is described in detail in all the embodiments, it should be noted that, in the following descriptions, drawings of the present disclosure are merely used as exemplary descriptions, are not necessarily drawn to scale, and not all details are necessarily presented in the drawings.

Directivity or terms approximate to the directivity described in the present disclosure, for example, orientation or position relationships indicated by the terms “front”, “rear”, “left”, “right” “top”, “bottom” “inside”, “outside” and “side” are based on orientation or position relationships shown in the drawings, are merely used to help describe and understand, rather than indicating or implying that the mentioned apparatus or component needs to have a particular orientation or need to be constructed and operated in a particular orientation. Therefore, such terms should not be construed as limiting of the present disclosure.

A quantifier “a” or “one” used for elements and components recorded in the present disclosure is merely used for ease of use and providing ordinary meanings of a scope of this creation. In the present disclosure, the quantifier should be interpreted as including one or at least one, and a singular concept also includes a plural situation, unless the concept obviously means otherwise. In addition, the terms “first”, “second” and the like are used for descriptive purposes only and are not to be construed as indicating or implying relative importance or implicitly indicating a quantity of technical features indicated. Therefore, a feature defined by “first” , “second”, or the like may explicitly or implicitly include one or more such features. In the descriptions of the present disclosure, unless otherwise stated, “a plurality of” means two or more than two.

Approximate terms such as “combine”, “group”, or “assemble” described in the present disclosure mainly include those that can be separated without damaging the components after connection, or those that make the components inseparable after connection. These approximate terms can be selected by a person of ordinary skill in the art according to materials of the components to be connected or assembly requirements.

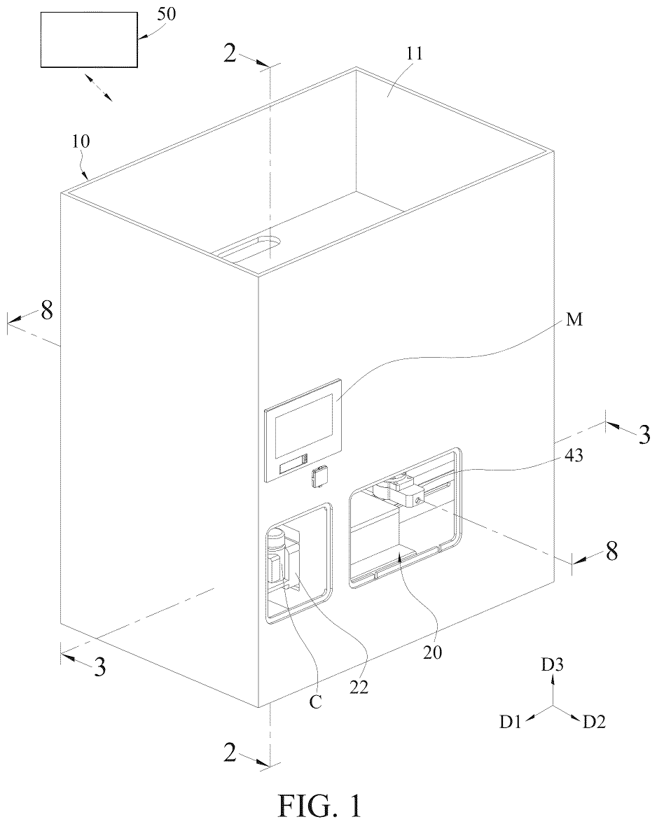

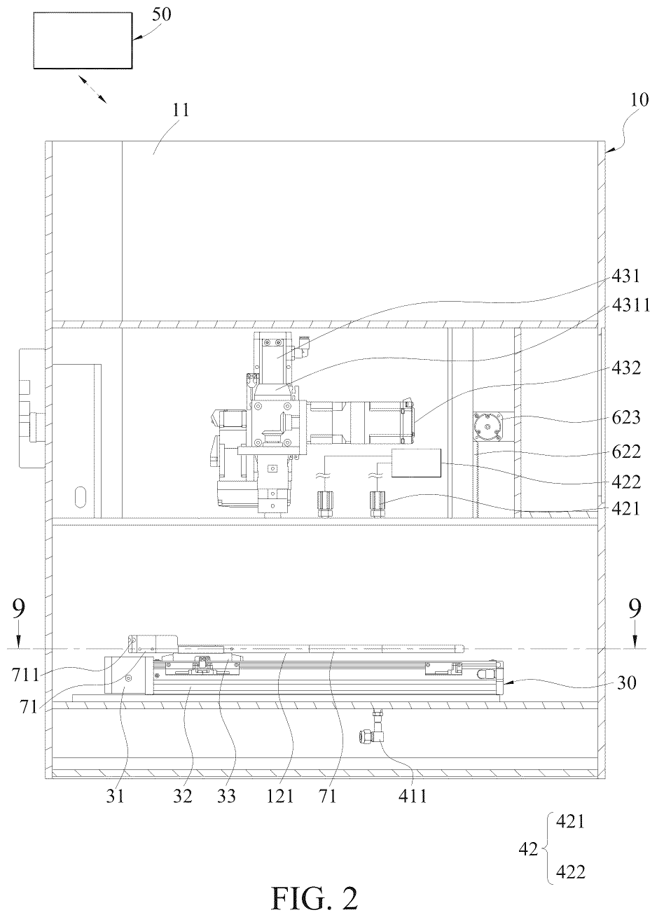

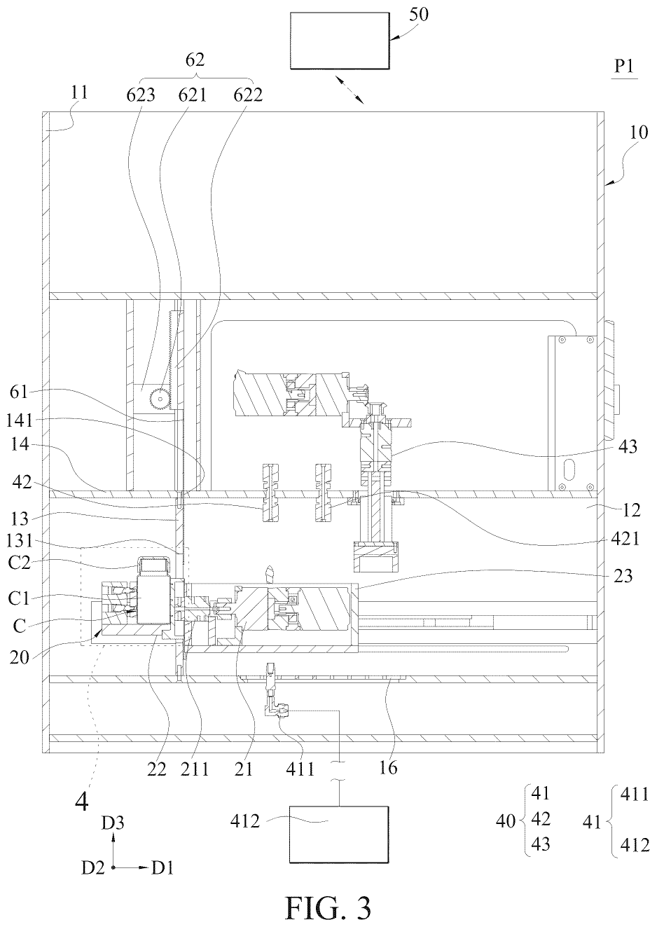

Referring to FIG. 1 to FIG. 3, FIG. 1 is a schematic diagram of an overall appearance of an automatic sampling device according to an embodiment of the present disclosure; FIG. 2 is a schematic cross-sectional view drawn along a section line 2-2 in FIG. 1; and FIG. 3 is a schematic cross-sectional view of a carrying module that is located at a first position and that is of an automatic sampling device according to an embodiment of the present disclosure and is drawn along a section line 3-3 in FIG. 1. The automatic sampling device is suitable for transferring a container C to automatically complete sampling. In some embodiments, the automatic sampling device can automatically load a sample that needs to be obtained into the container C. The container C includes a bottle body C1 and a bottle cap C2 detachably disposed on the bottle body C1. In these embodiments, the sample that needs to be obtained may be a chemical in a liquid form, but this is not limited in the present disclosure.

Referring to FIG. 1 to FIG. 3, the automatic sampling device includes a housing 10, a carrying module 20, a power module 30, an operation module 40, and a controller 50. The carrying module 20 includes a driving member 21 and a carrying base 22. The driving member 21 is disposed in the housing 10 and is linearly displaceable in a first direction D1. The carrying base 22 is connected to the driving member 21 and is driven by the driving member 21 to rotate about the first direction D1. The power module 30 is connected to the driving member 21 to drive the driving member 21 to be displaced in the first direction D1. The operation module 40 is disposed in a displacement path of the carrying module 20, and includes a cleaning unit 41, a sampling unit 42, and a bottle cap opening and closing unit 43. The cleaning unit 41, the sampling unit 42, and the bottle cap opening and closing unit 43 are configured at intervals. The controller 50 is electrically connected to the driving member 21, the power module 30, and the operation module 40.

In this way, the automatic sampling device can automatically complete a preliminary operation of a sampling operation and the sampling operation in the housing 10, and standardize a sampling process, so that pollution of the sampling operation can be avoided, and in addition to that, efficiency of the sampling operation can also be improved, and consistency of the sampling operation can be ensured. In addition, the carrying module 20 carries the container C to complete the automatic sampling operation in a linear displacement manner, so that a volume of an entire automatic sampling device can also be reduced, and field applicability is improved.

In some embodiments, the sample obtained by the automatic sampling device is the chemical, but this is not limited in the present disclosure. In these embodiments, because the chemical often needs to be used in an advanced manufacturing process in the semiconductor manufacturing industry, and with miniaturization of an integrated circuit, a cleanliness requirement for the chemical is very strict, the used chemical in a production line of the manufacturing process needs to be periodically detected, to ensure that the used chemical does not contain an impurity, a contaminant, or a metal ion that may affect a subsequent manufacturing process. In addition, to avoid generating pollution in a process in which the container C used for loading the chemical is transported to perform the sampling operation, usually, ultrapure water has already been loaded into the container C in advance, and the sampling operation needs to be performed in the following sequence: opening the bottle cap C2, pouring out the ultrapure water, cleaning the container, and finally, loading the chemical and closing the bottle cap C2. Sampling of the chemical is completed according to the foregoing procedures.

Referring to FIG. 1, the housing 10 is mainly configured to carry the carrying module 20, the power module 30, and the operation module 40, and provide a space for completing the automatic sampling operation. In some embodiments, the housing 10 is a hollow box body surrounded and formed by wall surfaces 11, and an inner space is surrounded and defined by the wall surfaces 11 of the housing 10. In this case, the sampling operation and the preliminary operation of the sampling operation can be performed in the inner space of the housing 10. In some embodiments, the wall surfaces 11 may be configured with a door panel that can be opened and closed by an operator, a see-through panel through which the operator can observe an operation condition, a control panel that can be operated by the operator, or any combination of the foregoing panels. This is not limited in the present disclosure. In the embodiment shown in FIG. 1, the housing 10 includes at least six wall surfaces 11, and the six wall surfaces 11 are perpendicularly connected to each other to form a hollow six-sided cube structure.

Referring to FIG. 1 and FIG. 3, the carrying module 20 is mainly configured to carry the container C and can drive the container C to linearly displaced in the first direction D1 to complete sampling of the chemical. The carrying base 22 of the carrying module 20 is provided to position the container C, and the driving member 21 can drive the carrying base 22 to rotate about the first direction D1 to perform operations of pouring out the ultrapure water and cleaning the container C.

Referring to FIG. 3, in some embodiments, the driving member 21 is a motor, and is configured to drive the carrying base 22 to rotate. In these embodiments, the driving member 21 may be, but is not limited to, a direct current motor or an alternating current motor. In some embodiments in which the driving member 21 is the direct current motor, the driving member 21 may be, but is not limited to, a brushed direct current motor or a brushless direct current motor; and in some embodiments in which the driving member 21 is the alternating current motor, the driving member 21 may be, but is not limited to, an induction motor, a servo motor, a synchronizer motor, a reduction motor, or a high-efficiency motor. In some embodiments in which the driving member 21 is the motor, the driving member 21 has a driving pivot 211, the driving pivot 211 can rotate about the first direction D1, and the carrying base 22 is connected to the driving pivot 211. It should be noted that, the driving member 21 may be, but is not limited to, the single motor or a combination of the motor and a reducer. In some embodiments, the driving member 21 is a combination of the servo motor and a planetary reducer.

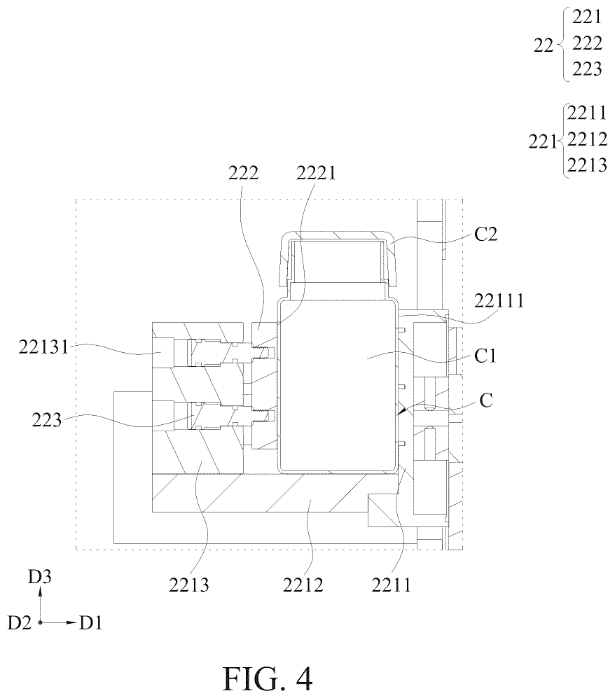

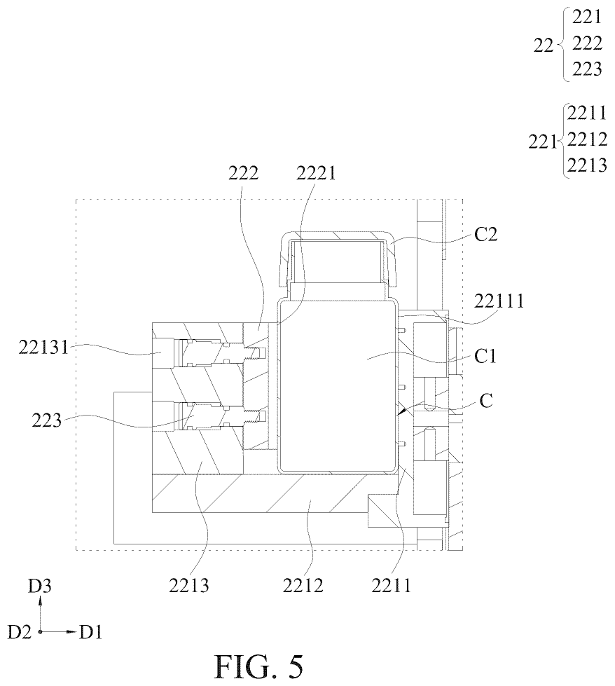

Referring to FIG. 4 and FIG. 5, FIG. 4 is a partially enlarged view of a part 4 circled in FIG. 3; and FIG. 5 is a schematic cross-sectional view of a carrying base of an automatic sampling device according to an embodiment of the present disclosure. In some embodiments, the carrying base 22 includes a fixed base 221 and a clamping member 222. The clamping member 222 is disposed on the fixed base 221 and is displaceable in the first direction D1 to clamp the bottle body C1 of the container C. In these embodiments, the driving pivot 211 of the driving member 21 is connected to the fixed base 221 of the carrying base 22 to drive the entire carrying base 22 to rotate about the first direction D1.

Referring to FIG. 4 and FIG. 5, in some embodiments, the fixed base 221 of the carrying base 22 has a first abutting portion 22111, the clamping member 222 has a second abutting portion 2221, the first abutting portion 22111 of the fixed base 221 abuts against one side of the bottle body C1 of the container C, and the second abutting portion 2221 of the clamping member 222 abuts against the other opposite side of the bottle body C1 of the container C. In some embodiments, the first abutting portion 22111 and the second abutting portion 2221 are respectively arc shapes, and are configured to carry the container C in a cylindrical shape.

Referring to FIG. 4 and FIG. 5, in some embodiments, the fixed base 221 of the carrying base 22 has a first side wall 2211, a bottom portion 2212, and a second side wall 2213 that are sequentially connected, and the first side wall 2211 and the second side wall 2213 are parallel and opposite to each other and are respectively connected to two opposite sides of the bottom portion 2212, so that an appearance form of the fixed base 221 is approximately in a U shape. It should be noted that, the appearance form of the fixed base 221 is merely an exemplary description, and this is not limited in the present disclosure. In these embodiments, the first abutting portion 22111 is located on a side of the first side wall 2211 facing toward the second side wall 2213. The carrying base 22 further includes a linkage 223, and the second side wall 2213 further includes a through port 22131. The linkage 223 is disposed at one end of the through port 22131 of the second side wall 2213 and is displaceable in the first direction D1, and a part of the linkage 223 extends toward the first side wall 2211. The clamping member 222 is disposed on the extending part of the linkage 223, so that the clamping member 222 is disposed on the second side wall 2213 and is displaceable in the first direction D1. In this way, the other end of the through port 22131 of the second side wall 2213 of the carrying base 22 can be connected to a pressure source, so that the linkage 223 can be driven by air/liquid to drive the clamping member 222 to be close to the first side wall 2211 (in a state shown in FIG. 4) or to be away from the first side wall 2211 of the fixed base 221 (in a state shown in FIG. 5), thereby implementing an operation of clamping or releasing the container C.

The power module 30 is configured to drive the driving member 21 to be displaced in the first direction D1. In some embodiments, the power module 30 and the carrying module 20 are located at different positions in a second direction D2 perpendicular to the first direction D1. In this case, the power module 30 is a linear driving assembly. In an embodiment, the power module 30 includes a power assembly 31, a linear guide assembly 32, and a driven member 33. The linear guide assembly 32 is connected to the power assembly 31 and is driven by the power assembly 31 to be linearly displaced in the first direction D1. The driven member 33 is connected to the linear guide assembly 32 and the driving member 21 of the carrying module 20 to drive the driving member 21 to be linearly displaced in the first direction D1 with the linear guide assembly 32. In some embodiments, the power module 30 may be disposed inside the housing 10, or may be disposed outside the housing 10. This is not limited in the present disclosure.

Referring to FIG. 2, in some embodiments, the power assembly 31 is a combination of a motor, a screw rod, and a screw cap. The motor is connected to the screw rod, the screw rod has a length extending in the first direction D1, and the screw cap is in threaded connection to the screw rod. In this case, the motor drives the screw rod to rotate about the first direction D1. When the screw rod rotates, the screw cap that is in threaded connection to the screw rod is linearly displaced in the first direction D1 on the screw rod. In these embodiments, the linear guide assembly 32 is a combination of a linear guide rail and a linear slider. The linear guide rail has a length extending in the first direction D1, and the linear slider is slidably sleeved on the linear guide rail. In this way, the linear slider is connected to the screw cap of the power assembly 31, so that when the screw cap is linearly displaced in the first direction D1, the linear slider of the linear guide assembly 32 can be driven by the screw cap and is guided by the linear guide rail to be linearly displaced in the first direction D1 in a stable manner. In some embodiments, the driven member 33 is of a plate structure, and the driven member 33 traverses, in the second direction D2, between the linear slider connected to the linear guide assembly 32 and the driving member 21 of the carrying module 20. In this way, the power module 30 can drive the driving member 21 of the carrying module 20 to be linearly displaced in the first direction D1.

Referring to FIG. 2 and FIG. 3, the cleaning unit 41 of the operation module 40 and the bottle cap opening and closing unit 43 of the operation module 40 are located at different positions in the first direction D1; and the cleaning unit 41 and the sampling unit 42 may be located at a same position in the first direction D1, or may be located at different positions in the first direction D1. In this way, when the power module 30 drives the carrying module 20 to be displaced in the first direction D1, the container C on the carrying module 20 can respectively complete operations of container C cleaning, chemical sampling, and bottle cap C2 opening and closing at positions corresponding to the cleaning unit 41, the sampling unit 42, and the bottle cap opening and closing unit 43.

Referring to FIG. 2 and FIG. 3, in some embodiments, at a position in the first direction D1, the cleaning unit 41 of the operation module 40 is located at one end of the displacement path of the carrying module 20, and the bottle cap opening and closing unit 43 is located at the other end of the displacement path of the carrying module 20. In these embodiments, the sampling unit 42 includes a sampling head 421 and a sample providing module 422. The sampling head 421 is connected to the sample providing module 422. The sample providing module 422 provides a sample that needs to be detected and the sample is loaded into the container C through the sampling head 421.

Referring to FIG. 2 and FIG. 3, in some embodiments, a quantity of sample providing modules 422 may be one or more than one. When the quantity of sample providing modules 422 is more than one, a quantity of sampling heads 421 corresponds to the quantity of sample providing modules 422. In this way, different samples can be respectively provided by the sample providing modules 422 and are loaded into the container C, and a cross pollution condition can be avoided.

Referring to FIG. 2 and FIG. 3, when the quantity of sample providing modules 422 is more than one, a position of the sampling head 421 of the sampling unit 42 in the first direction D1 may be the same as a position of the cleaning unit 41; or a position of the sampling head 421 of the sampling unit 42 in the first direction D1 may be different from a position of the cleaning unit 41. In the embodiment shown in FIG. 3, a position of one sampling head 421 in the first direction D1 is the same as the position of the cleaning unit 41; and a position of a sampling head 421 of another sampling unit 42 in the first direction D1 is different from the position of the cleaning unit 41, and the sampling head 421 of the sampling unit 42 is located between the cleaning unit 41 and the bottle cap opening and closing unit 43.

It should be noted that, the position configuration of the operation module 40 is merely exemplary. This is not limited in the present disclosure. In other words, a user may change the position configuration of the operation module 40 according to content of the sampling operation, space configuration of the housing 10, pipeline configuration, or various different requirements.

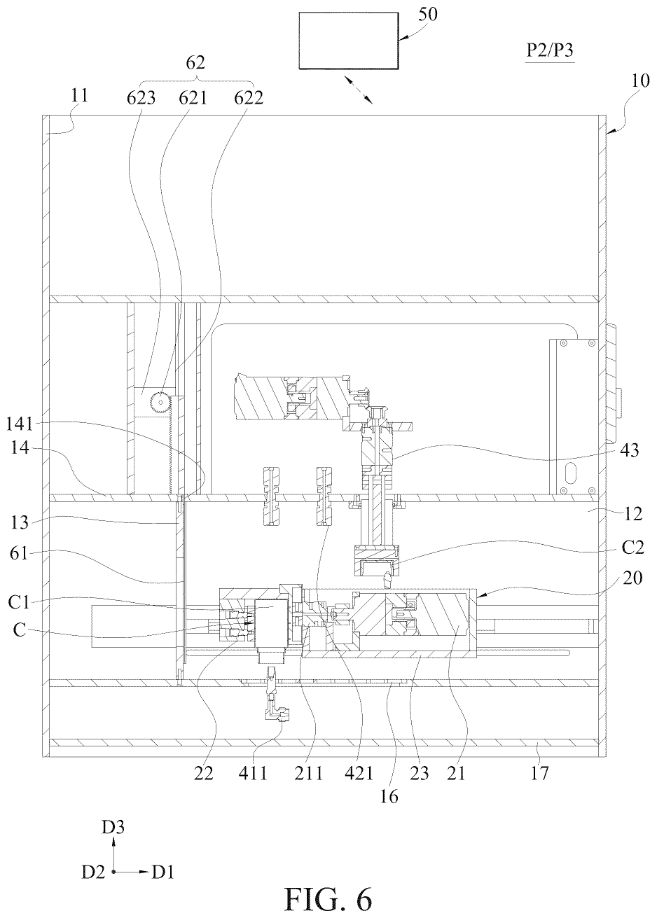

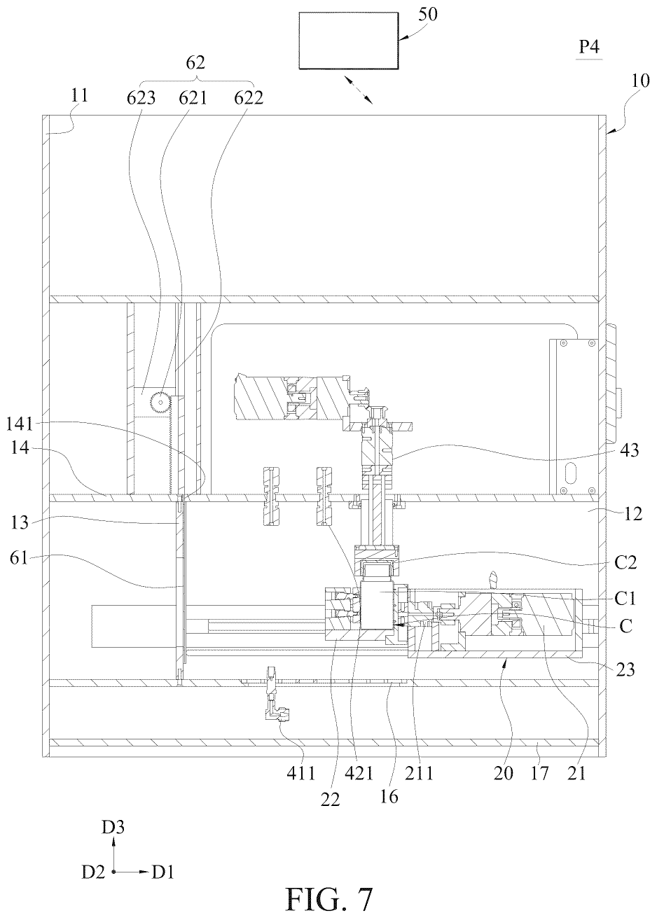

Referring to FIG. 3, FIG. 6, and FIG. 7, FIG. 6 is a schematic cross-sectional view of a carrying module that is located at a second position and a third position and that is of an automatic sampling device according to an embodiment of the present disclosure; and FIG. 7 is a schematic cross-sectional view of a carrying module that is located at a fourth position and that is of an automatic sampling device according to an embodiment of the present disclosure. In some embodiments in which the operation module 40 includes the cleaning unit 41, the sampling unit 42, and the bottle cap opening and closing unit 43, the carrying module 20 may be sequentially displaced between the first position P1, the second position P2, the third position P3, and the fourth position P4 in the first direction D1. At a position in the first direction D1, the second position P2 corresponds to the cleaning unit 41, the third position P3 corresponds to the sampling unit 42, and the fourth position P4 corresponds to the bottle cap opening and closing unit 43. In the embodiment shown in FIG. 6, the second position P2 may be the same as the third position P3, and the second position P2 may also be different from the third position P3.

Referring to FIG. 3, in some embodiments, the cleaning unit 41 includes a spraying head 411 and a cleaning liquid providing module 412. The spraying head 411 is disposed in the housing 10 and is connected to the cleaning liquid providing module 412. The cleaning liquid providing module 412 provides cleaning liquid to clean the container C. In some embodiments, the cleaning liquid may be, but is not limited to, high oxidation cleaning liquid (such as H₂O₂ (H₂O₂)) or ultrapure water (Ultrapure Water, UPW). In some embodiments, a quantity of cleaning liquid providing modules 412 may be one or more than one. When the quantity of cleaning liquid providing modules 412 is more than one, the cleaning liquid providing modules 412 are first connected to a control valve, and the control valve is then connected to the spraying head 411. Different cleaning liquid is provided through control of the control valve to clean the container C.

The controller 50 is configured to control the carrying module 20, the power module 30, and the operation module 40 to automatically complete the chemical sampling operation. In some embodiments, the controller 50 may be, but is not limited to, an electronic device that has various integrated circuits, logics, memories (including non-transitory media), and/or software, and can receive an instruction, send an instruction, and control an operation. In some embodiments, the controller 50 may be, but is not limited to, a control chip, or may be a programmable logic controller (Programmable Logic Controller, PLC) control circuit. In some embodiments, the controller 50 may be a part of a computer or be coupled to a computer, and the computer may be integrated into the automatic sampling device, coupled to the automatic sampling device, or connected to a wireless signal of the automatic sampling device.

In view of the foregoing descriptions, when the automatic sampling device performs the chemical sampling operation, the controller 50 can control operations of the carrying module 20, the power module 30, and the operation module 40, and specific descriptions are provided below. First, the controller 50 controls the power module 30 to drive the carrying module 20 to be displaced to the first position P1 (in a state shown in FIG. 3), and then controls the clamping member 222 of the carrying base 22 of the carrying module 20 to be away from the fixed base 221 (in a state shown in FIG. 5), so that the carrying base 22 is in a state in which the container C can be freely removed and placed. In addition, the controller 50 controls the driving member 21 to drive and rotate the carrying base 22 into a carrying form in which the bottom portion 2212 of the carrying base 22 is at a lower position.

In this state, the user/robot places the container C in the carrying base 22 of the carrying module 20, and then the controller 50 controls the clamping member 222 of the carrying base 22 to be displaced toward the fixed base 221 to clamp and position the container C (in a state show in FIG. 4). In some embodiments, the controller 50 may control clamping of the carrying base 22 according to trigger of a manual switch. In other embodiments, a sensor is disposed on the carrying base 22. The sensor can sense whether the container C is carried on the carrying base 22, and the controller 50 may control clamping of the carrying base 22 according to a sensing signal of the sensor. In this case, the sensor may be, but is not limited to, a photo interrupter.

In some embodiments in which clamping of the carrying base 22 is driven by air/liquid, the controller 50 controls displacement of the clamping member 222 by implementing adjustment and control of an air/liquid pressure source to further implement control of clamping and releasing.

After the container C is clamped and positioned on the carrying base 22 of the carrying module 20, the controller 50 controls the power module 30 to drive the carrying module 20 to be displaced to the fourth position P4 (in a state shown in FIG. 7). In this state, a position of the carrying base 22 of the carrying module 20 in the first direction D1 overlaps with a position of the bottle cap opening and closing unit 43. Next, the controller 50 controls the bottle cap opening and closing unit 43 to open the bottle cap C2 of the container C.

After the bottle cap C2 of the container C is opened, the controller 50 controls the power module 30 to drive the carrying module 20 to be displaced to the second position P2 (as shown in FIG. 6). In this state, a position of the carrying base 22 of the carrying module 20 in the first direction D1 overlaps with a position of the cleaning unit 41 and a position of the sampling unit 42. Herein, the controller 50 controls the driving member 21 of the carrying module 20 to rotate, and further the carrying base 22 is driven to rotate, so that the container C on the carrying base 22 is in a state in which a bottle mouth of the container C faces downward. In this case, content originally loaded into the container C is poured out, and then the controller 50 controls the cleaning unit 41 to clean the inside of the bottle body C1 from the bottle mouth of container C.

After the inside of the bottle body C1 of the container C is cleaned, when the position of the sampling head 421 of the sampling unit 42 in the first direction D1 overlaps with the position of the cleaning unit 41 (that is, the second position P2 is the same as the third position P3) (in a state as shown in FIG. 6), the controller 50 may continue to control the sampling unit 42 to output a sample that needs to be loaded and the sample is loaded into the container C. And when the position of the sampling head 421 of the sampling unit 42 in the first direction D1 does not overlap with the position of the cleaning unit 41 (that is, the second position P2 is different from the third position P3), the controller 50 controls the power module 30 to drive the carrying module 20 to be displaced from the second position P2 to the third position P3. In this state, the position of the carrying base 22 of the carrying module 20 in the first direction D1 overlaps with the position of the sampling unit 42. Herein, the controller 50 controls the driving member 21 of the carrying module 20 to rotate, and further the carrying base 22 is driven to rotate into a state in which the bottle mouth of the container C faces upward and faces toward the sampling unit 42. Next, the controller 50 controls the sampling unit 42 to output the sample that needs to be loaded and the sample is loaded into the container C.

After the container C is loaded with the sample, the controller 50 controls the power module 30 to drive the carrying module 20 to be displaced to the fourth position P4 (in the state shown in FIG. 7). In this state, a position of the carrying base 22 of the carrying module 20 in the first direction D1 overlaps with the position of the bottle cap opening and closing unit 43. Next, the controller 50 controls the bottle cap opening and closing unit 43 to put the bottle cap C2 on the container C.

After the container C is loaded with the sample and bottle cap C2 is put on the container C, the controller 50 controls the power module 30 to drive the carrying module 20 to be displaced to the first position P1 (in a state shown in FIG. 3). In this state, the operator/robot can remove, at the first position P1, the container C that has completed sample filling, to complete the sampling operation.

Referring to FIG. 1, in some embodiments, the controller 50 may be, but is not limited to, controlling time during which the power module 30 drives the carrying module 20 to be displaced to complete transferring between different positions, and controlling enabling of the cleaning unit 41, enabling of the sampling unit 42, and enabling of the bottle cap opening and closing unit 43 according to the displacement time. However, this is not limited in the present disclosure. In other embodiments, the automatic sampling device further includes a display M, and the controller 50 is electrically connected to the display M. The user may control and complete, through the display M, the steps of the transferring operation and the sampling operation in a manual control manner.

It should be noted that, the foregoing sampling operating procedures are merely exemplary descriptions. In some specific embodiments, the sampling operating procedures controlled by the controller 50 may be adjusted according to a requirement, for example, to increase a quantity of stopping positions of the carrying module 20, and to distinguish between a position at which the carrying module 20 drives the container C to pour out the original content and a position at which the cleaning operation is performed, so that pollution in different operating rooms can be further reduced.

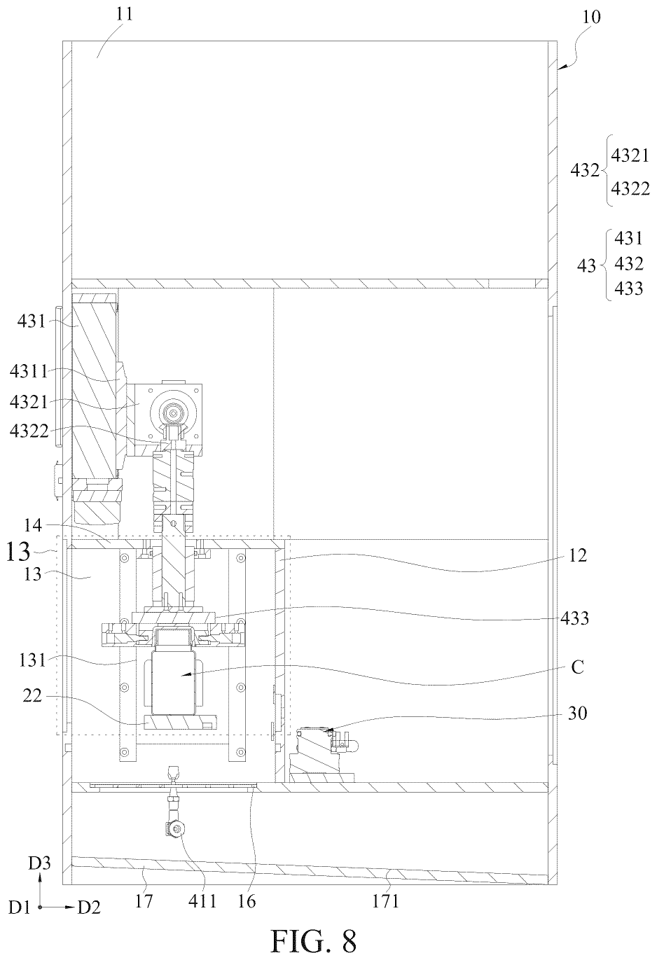

Referring to FIG. 2 and FIG. 8, FIG. 8 is a cross-sectional view 1 of an automatic sampling device from another perspective according to an embodiment of the present disclosure and is drawn along a section line 8 -8 in FIG. 1. In some embodiments, the housing 10 further includes a first partition 12, and the first partition 12 extends in the first direction D1 and extends between two opposite wall surfaces 11. The carrying module 20 and the operation module 40 are located in a space on one side of the first partition 12, and the power module 30 is located in a space on the other side of the first partition 12. In these embodiments, the first partition 12 has a long hole 121 extending in the first direction D1, and the long hole 121 runs through the first partition 12. The power module 30 is connected to the driving member 21 of the carrying module 20 through the long hole 121. In this way, the first partition 12 can separate the power module 30 from the operation module 40 and the carrying module 20, to avoid a case in which the power module 30 is damaged because the cleaning liquid or the sample is splashed to the power module 30 during the sampling operation. In addition, because the power module 30 may include a component made of a metal material, through partition of the first partition 12, a case in which a metal particle generated by the power module 30 pollutes the sample may be reduced, and the sampling precision is improved.

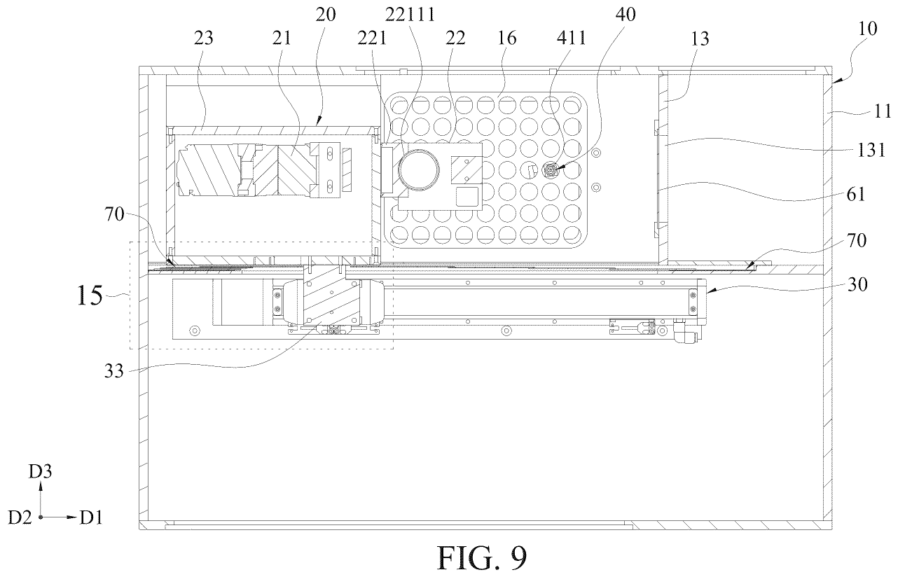

Referring to FIG. 3 and FIG. 9, FIG. 9 is a schematic cross-sectional view of an automatic sampling device from still another perspective according to an embodiment of the present disclosure. In some embodiments, the housing 10 further includes a second partition 13, and one end of the second partition 13 is angularly connected to the first partition 12 and the second partition 13 has a pass-through port 131. The second partition 13 and the carrying module 20 are located on a same side of the first partition 12, and the operation module 40 is located on one side of the second partition 13. In this way, the carrying base 22 of the carrying module 20 may enter the other side of the second partition 13 through the pass-through port 131, so that the other side of the second partition 13 may serve as a region for removing and placing the container C. Because the region for removing and placing the container C needs to be open to be in communication with the outside of the housing 10, in these embodiments, the operation module 40 is isolated from the region for removing and placing the container C. In this way, a case in which various pollution sources outside the housing 10 may pollute a space in which the sampling operation is performed in a process of removing and placing the container C is avoided. In these embodiments, when the carrying module 20 is located at the first position P1, the carrying base 22 is located, through the pass-through port 131, on the other side of the second partition 13.

Referring to FIG. 3 and FIG. 8, in some embodiments in which the cleaning unit 41 includes the spraying head 411, the housing 10 further includes a platform 16. The platform 16 is disposed in the housing 10, and the platform 16 is perpendicular to the first partition 12 and the second partition 13. In these embodiments, the platform 16 is located at a lower position in the housing 10. In this case, the spraying head 411 of the cleaning unit 41 can be disposed on the platform 16 to perform the cleaning operation on the container C in a stable posture.

In some embodiments, the spraying head 411 of the cleaning unit 41 is rotatably disposed on the platform 16. When the cleaning liquid providing module 412 outputs the cleaning liquid, the cleaning liquid is rotatably output by the spraying head 411 to clean the container C in a comprehensive manner. In other embodiments, the spraying head 411 may also be fixedly disposed on the platform 16. In these embodiments, the spraying head 411 has a through port provided around an external surface of the spraying head 411, so that when the cleaning liquid providing module 412 outputs the cleaning liquid, the cleaning liquid needs to be output through the through port provided around the external surface of the spraying head 411, thereby cleaning the container C in a comprehensive manner.

Referring to FIG. 8 and FIG. 9, in some embodiments, the platform 16 is a mesh plate. In this way, the original content poured out from the container C or the cleaning liquid output in the cleaning process is prevented from being accumulated on the platform 16, and a case in which the sampling operation may be polluted by various operating solutions or samples that are generated in the sampling operation process and that are accumulated on the platform 16 is avoided. In some embodiments in which the housing 10 includes the platform 16, the housing 10 further includes a holding plate 17, and the holding plate 17 is disposed in the housing 10 and is located below the platform 16. In this way, the holding plate 17 can hold various operating solutions or samples that fall from the platform 16, to further collectively drain the operating solutions or the samples, thereby facilitating cleaning. In some embodiments, the holding plate 17 has an inclined surface 171, and the inclined surface 171 is inclined relative to the platform 16. In this way, after the various operating solutions or the samples falling from the platform 16 are collected in the holding plate 17, the various operating solutions or the samples can be automatically gathered to a lower position, so that convenience of the cleaning operation is improved.

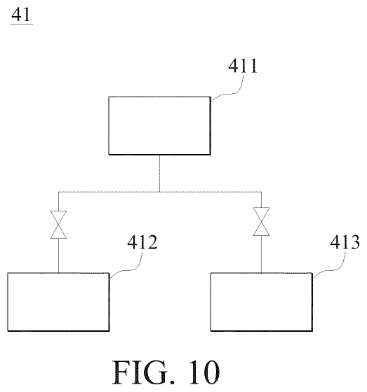

Referring to FIG. 10, FIG. 10 is a schematic block diagram of a cleaning unit of an automatic sampling device according to an embodiment of the present disclosure. In some embodiments, a cleaning unit 41 further includes a drying module 413. In these embodiments, a spraying head 411 is connected to the drying module 413 through a control valve, and the drying module 413 can output a drying medium. The drying medium is, for example, but not limited to, air or pure nitrogen. In this case, after the cleaning unit 41 outputs cleaning liquid from a spraying head 411 through a cleaning liquid providing module 412 to clean the container C, the cleaning liquid providing module 412 may be then changed to the drying module 413 through control of the control valve, and the drying module 413 outputs the drying medium to the container C, to dry the container C through the drying medium. In this way, it is ensured that no cleaning liquid remains in the container C, and the container C can load the sample in a dry state, thereby ensuring correctness of the obtained sample.

Referring to FIG. 3, FIG. 6, and FIG. 7, in some embodiments, the automatic sampling device further includes a door sheet 61 and a driving assembly 62. The driving assembly 62 is disposed in the housing 10. The door sheet 61 is connected to the driving assembly 62. The driving assembly 62 can drive the door sheet 61 to be displaced in a third direction D3 perpendicular to the first direction D1 and the second direction D2 to open and close the pass-through port 131 of the second partition 13. In this way, after the container C is placed in the carrying base 22 of the carrying module 20, the pass-through port 131 is closed, to avoid a case in which a pollution source from the outside of the housing 10 pollutes an operating space in which the operation module 40 is located.

Referring to FIG. 3, FIG. 6, and FIG. 7, in some embodiments, the driving assembly 62 includes a gear 621, a rack 622, and a power source 623. The gear 621 is rotatably disposed in the housing 10. The rack 622 has a length extending in the third direction D3 and the rack 622 is fixed to the door sheet 61 and is meshed with the gear 621. The power source 623 is connected to the gear 621. In this way, when the power source 623 is started, the power source 623 drives the gear 621 to rotate. When the gear 621 rotates, the rack 622 can be driven to be linearly displaced in the third direction D3, and the door sheet 61 is further driven to open and close the pass-through port 131. In these embodiments, the gear 621 can rotate about the second direction D2 and is disposed in the housing 10.

Referring to FIG. 3, FIG. 6, and FIG. 7, in some embodiments, the housing 10 further includes a third partition 14. The third partition 14 is angularly connected to one end of the first partition 12 and one end of the second partition 13. In addition, in the housing 10, the third partition 14 can distinguish spaces in different positions in the third direction D3. In these embodiments, the third partition 14 is perpendicular to the first partition 12, and the gear 621 and the power source 623 are located on a side of the third partition 14 away from the second partition 13. The third partition 14 has a through cut 141, and the door sheet 61 may be accommodated in the cut 141 and be displaceable in the third direction D3 between two sides of the third partition 14. In this case, the gear 621 and the power source 623 can be segmented from a removing and placing space of the container C, and displacement of the door sheet 61 can also be limited by the cut 141, so that the door sheet 61 is stably displaced in a correct path.

Referring to FIG. 3, in some embodiments, the carrying module 20 further includes a box body 23, and the driving member 21 is accommodated in the box body 23. The carrying base 22 is located outside the box body 23, and the driving pivot 211 of the driving member 21 extends out of the box body 23 and is connected to the carrying base 22, and the power module 30 is connected to the box body 23. In this way, the driving member 21 can be isolated from the space in which the sampling operation is performed, so that a case in which the cleaning liquid or the sample is sprayed to or stains the driving member 21 during the sampling operation is avoided, to ensure that the driving member 21 can operate in a stable manner. In some embodiments, the box body 23 is made of a non-metal material, to prevent the box body 23 from generating the metal particle to pollute the sample.

Referring to FIG. 3, in some embodiments, a quantity of spraying heads 411 of the cleaning unit 41 is more than one, where one of the spraying heads 411 is rotatably disposed on the platform 16, and one of the spraying heads 411 is rotatably disposed on the box body 23 of the carrying module 20. In this way, the spraying head 411 disposed on the platform 16 can clean the bottle body C1 of the container C, and the spraying head 411 disposed on the box body 23 can clean the bottle cap C2 clamped on the bottle cap opening and closing unit 43, so that the bottle body C1 and the bottle cap C2 of the container C are fully cleaned.

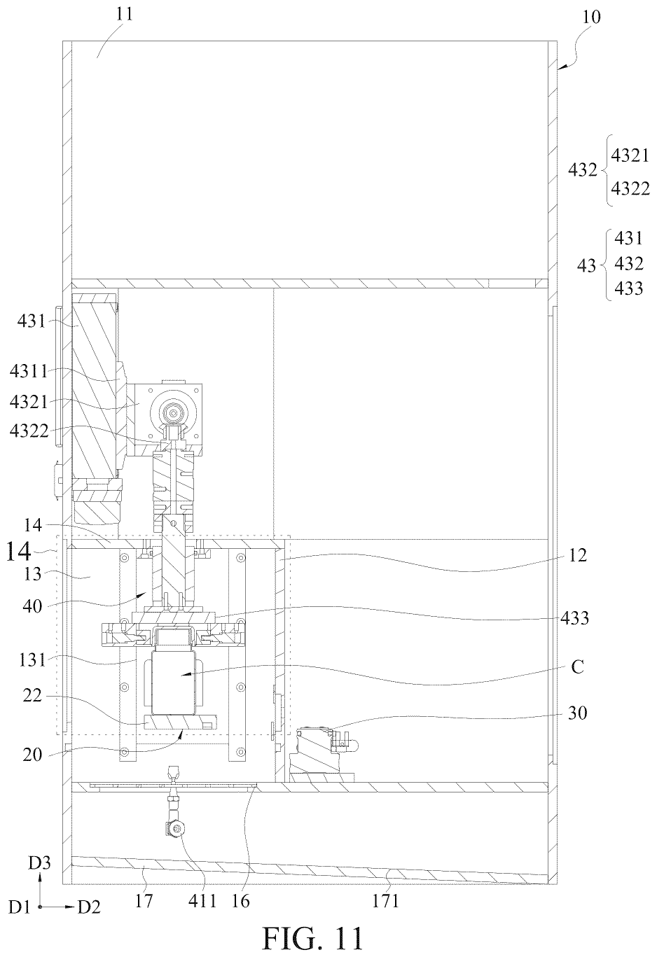

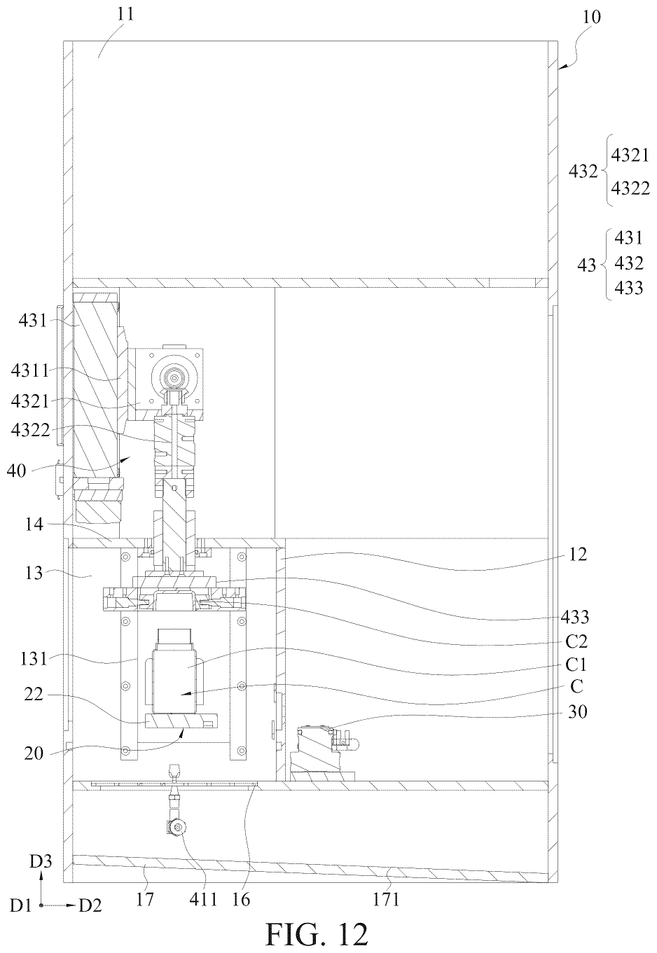

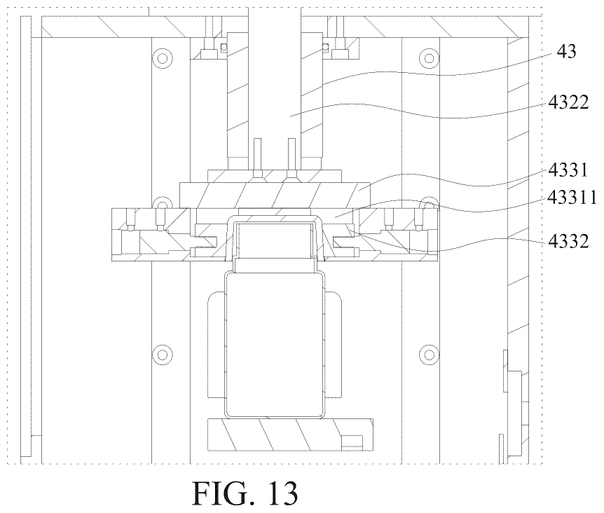

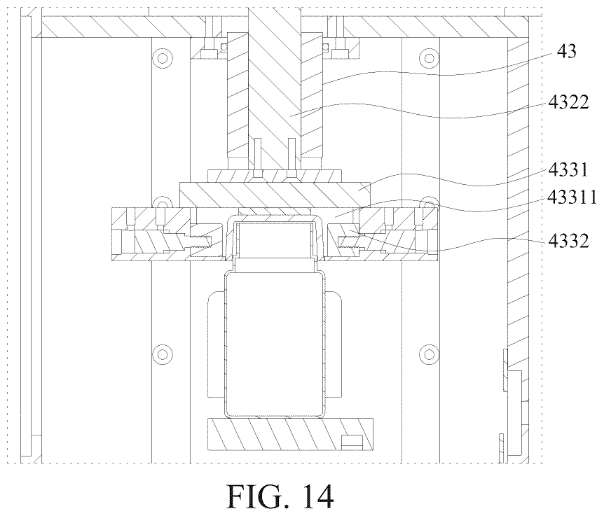

Referring to FIG. 8, and FIG. 11 to FIG. 14, FIG. 11 is a cross-sectional view 2 of an automatic sampling device from another perspective according to an embodiment of the present disclosure; FIG. 12 is a cross-sectional view 3 of an automatic sampling device from another perspective according to an embodiment of the present disclosure; FIG. 13 is a partially enlarged view of a part 13 circled in FIG. 8; and FIG. 14 is a partially enlarged view of a part 14 circled in FIG. 11. In some embodiments, the bottle cap opening and closing unit 43 includes a lifting module 431, a rotating module 432, and a clamping module 433. The lifting module 431 is fixed to the housing 10, the rotating module 432 is connected to the lifting module 431, and the clamping module 433 is connected to the rotating module 432. In this way, the lifting module 431 can drive the rotating module 432 to be displaced in the third direction D3 to be close to the container C (in a state shown in FIG. 8) or to be away from the container C (in a state shown in FIG. 12), and when the rotating module 432 is close to the container C, the clamping module 433 is clamped on the bottle cap C2 of the container C (as shown in FIG. 8 and FIG. 13) or releases the bottle cap C2 of the container C (as shown in FIG. 11 and FIG. 14), and the rotating module 432 rotates to open and close the bottle cap C2, to complete an operation of unlocking or locking the bottle cap C2.

Referring to FIG. 8, and FIG. 11 to FIG. 14, in some embodiments, the lifting module 431 has a sliding table 4311, and the sliding table 4311 can slide in the third direction D3. The rotating module 432 is connected to the sliding table 4311 and is driven by the sliding table 4311 to be displaced in the third direction D3.

Referring to FIG. 8, and FIG. 11 to FIG. 14, in some embodiments, the rotating module 432 includes a motor 4321 and a driving shaft 4322. The motor 4321 is fixed to the sliding table 4311. The driving shaft 4322 is connected to the motor 4321 and can rotate about the third direction D3. The clamping module 433 is connected to the driving shaft 4322. In this way, when the clamping module 433 can be clamped on the bottle cap C2, and the motor 4321 of the rotating module 432 operates, the bottle cap C2 can be driven to rotate through the driving shaft 4322 and the clamping module 433 to complete the operation of unlocking or locking the bottle cap C2. In some embodiments, to satisfy configuration requirements of different spaces, the driving shaft 4322 that drives the bottle cap C2 to rotate may be a rotating shaft of the motor 4321, or may be a driving shaft 4322 that is independent of the motor 4321 and that is connected between a rotating shaft of the motor 4321 and the clamping module 433. In some embodiments in which the driving shaft 4322 is the driving shaft 4322 that is independent of the motor 4321 and that is connected between the rotating shaft of the motor 4321 and the clamping module 433, the rotating shaft of the motor 4321 and the driving shaft 4322 may be connected through a bevel gear, so that the motor 4321 can be set to different directions, thereby improving applicability of space usage.

Referring to FIG. 8, and FIG. 11 to FIG. 14, in some embodiments, the clamping module 433 includes a kit 4331 and two clamping members 4332. The kit 4331 has a sleeve 43311, and the clamping members 4332 may be disposed on two opposite sides of the sleeve 43311 and be linearly displaceable. In this way, the clamping module 433 can be coated on the outside of the bottle cap C2 of the container C by using the sleeve 43311 of the kit 4331, and the clamping members 4332 are linearly displaced to be clamped and positioned on the bottle cap C2 or release the bottle cap C2. In some embodiments, the clamping members 4332 may be structural configuration that is driven by air/liquid to perform linear displacement. However, this is not limited in the present disclosure.

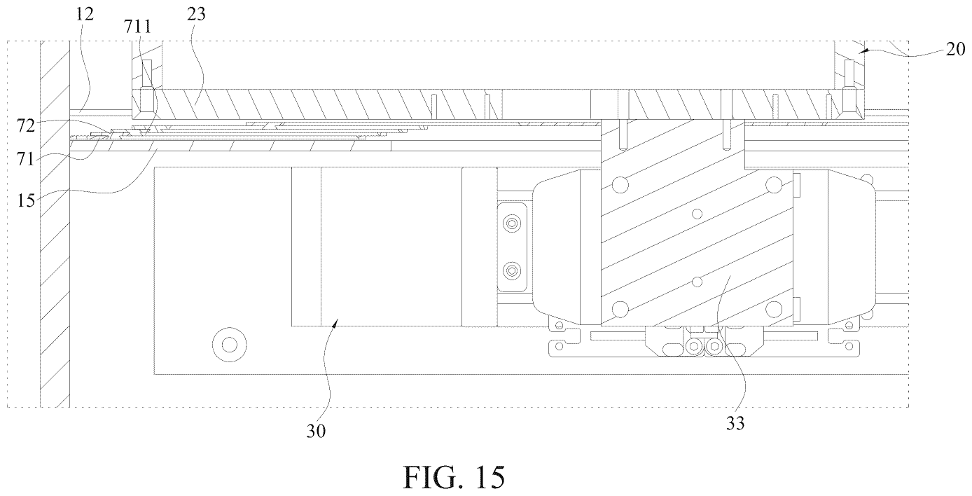

Referring to FIG. 9 and FIG. 15, FIG. 15 is a partially enlarged cross-sectional view of a part 15 circled in FIG. 9. In some embodiments, the automatic sampling device further includes two sliding sheet groups 70, respectively disposed on a side of the first partition 12 away from the carrying module 20. Each of the sliding sheet groups 70 includes a plurality of sliding sheets 71 and a plurality of limiting members 72. The sliding sheets 71 are parallel to each other and at least partially overlap, and each of the sliding sheets 71 has a sliding groove 711 provided in the first direction D1. Each of the limiting members 72 is slidably disposed in the sliding grooves 711 of two adjacent sliding sheets 71. In each sliding sheet group 70, the sliding sheet 71 closest to the first partition 12 is fixed to the carrying module 20, and the sliding sheet 71 farthest from the first partition 12 is fixed to the housing 10. Sliding sheets 71 of each of the sliding sheet groups 70 farthest away from the first partition 12 are respectively fixed to two end positions of the housing 10 in the first direction D1. In this way, when the carrying module 20 is linearly displaced in the first direction D1, the carrying module 20 can synchronously drive the sliding sheet groups 70, so that the sliding sheet groups 70 synchronously block the long hole 121 of the first partition 12 with the displacement of the carrying module 20. In this way, spaces on two sides of the first partition 12 can be kept isolated during the displacement of the carrying module 20, to avoid polluting the space in which the sampling operation is performed.

In some embodiments, the sliding sheet 71 closest to the first partition 12 is fixed to an outer surface of the box body 23 of the carrying module 20.

In some embodiments, the housing 10 further includes fourth partitions 15, and the fourth partitions 15 are spaced in parallel on the side of the first partition 12 away from the carrying module 20. In this way, the sliding sheet groups 70 can slide between the first partition 12 and the fourth partition 15, to improve operating smoothness of the sliding sheet groups 70. In these embodiments, sliding sheets 71 of each of the sliding sheet groups 70 farthest away from the first partition 12 are respectively fixed to the fourth partition 15.

What is claimed is:

1. An automatic sampling device, suitable for transferring a container to automatically complete sampling, and comprising:
a housing;
a carrying module, comprising:
a driving member, wherein the driving member is disposed in the housing and is linearly displaceable in a first direction; and
a carrying base, wherein the carrying base is connected to the driving member and is driven by the driving member to rotate about the first direction;
a power module, connected to the driving member to drive the driving member to be displaced in the first direction;
an operation module, disposed on a displacement path of the carrying module, and comprising a cleaning unit, a sampling unit, and a bottle cap opening and closing unit, wherein the cleaning unit, the sampling unit, and the bottle cap opening and closing unit are configured at intervals; and
a controller, electrically connected to the driving member, the power module, and the operation module.

2. The automatic sampling device according to claim 1, wherein a direction perpendicular to the first direction is a second direction, and the power module and the carrying module are respectively located at different positions in the second direction in the housing.

3. The automatic sampling device according to claim 1, wherein the housing further comprises a first partition, the first partition extends in the first direction and is parallel to the carrying module, the first partition has a long hole, the long hole has a length extending in the first direction, the carrying module and the power module are respectively located on opposite sides of the first partition, and the power module is connected to the driving member through the long hole.

4. The automatic sampling device according to claim 1, wherein the carrying module further comprises a box body, the driving member is accommodated inside the box body, the carrying base is located outside the box body, and the power module is connected to the box body.

5. The automatic sampling device according to claim 1, wherein the carrying base comprises a fixed base and a clamping member, the fixed base is connected to the driving member, and the clamping member is disposed on a side of the fixed base and is linearly displaceable in the first direction.

6. The automatic sampling device according to claim 3, wherein the housing further comprises a second partition, one end of the second partition is angularly connected to the first partition and the second partition has a pass-through port, the second partition and the carrying module are located on a same side of the first partition, and the operation module is located on a side of the second partition.

7. The automatic sampling device according to claim 6, wherein the carrying module is sequentially displaced between a first position, a second position, a third position, and a fourth position in the first direction, and when the carrying module is located at the first position, the carrying base is located on the other side of the second partition through the pass-through port.

8. The automatic sampling device according to claim 7, further comprising a door sheet and a driving assembly, wherein a direction perpendicular to the first direction is a second direction, the driving assembly is disposed in the housing, the door sheet is connected to the driving assembly, and the driving assembly is capable of driving the door sheet to be displaced in a third direction perpendicular to the first direction and the second direction to open and close the pass-through port.

9. The automatic sampling device according to claim 8, wherein the driving assembly comprises a gear, a rack, and a power source, the gear is rotatably disposed in the housing, the rack has a length extending in the third direction and the rack is fixed to the door sheet and is meshed with the gear, and the power source is connected to the gear.

10. The automatic sampling device according to claim 1, wherein the bottle cap opening and closing unit comprises a lifting module, a rotating module, and a clamping module, the lifting module is fixed to the housing, the rotating module is connected to the lifting module, and the clamping module is connected to the rotating module.

11. The automatic sampling device according to claim 10, wherein the lifting module has a sliding table, the sliding table is slidable in a third direction perpendicular to the first direction, and the rotating module is connected to the sliding table.

12. The automatic sampling device according to claim 11, wherein the rotating module comprises a motor and a driving shaft, the motor is fixed to the sliding table, the driving shaft is connected to the motor and is capable of rotating about the third direction, and the clamping module is connected to the driving shaft.

13. The automatic sampling device according to claim 10, wherein the clamping module comprises a kit and two clamping members, the kit has a sleeve, and the clamping members are disposed on two opposite sides of the sleeve and are linearly displaceable.

14. The automatic sampling device according to claim 3, further comprising two sliding sheet groups, wherein the two sliding sheet groups are respectively disposed on a side of the first partition away from the carrying module, each of the sliding sheet groups comprises a plurality of sliding sheets and a plurality of limiting members, the sliding sheets are parallel to each other and at least partially overlap, each of the sliding sheets has a sliding groove provided in the first direction, and each of the limiting members is slidably disposed in sliding grooves of two adjacent sliding sheets, wherein in each sliding sheet group, the sliding sheet closest to the first partition is fixed to the carrying module, and the sliding sheet farthest from the first partition is fixed to the housing.

15. The automatic sampling device according to claim 14, wherein the housing further comprises fourth partitions, the fourth partitions are spaced in parallel on the side of the first partition away from the carrying module, and the sliding sheet groups are located between the first partition and the fourth partition.
